(19) United States
(12) Patent Application Publication
(10) Pub. No.: US 2019/0272508 A1
(43) Pub. Date: Sep. 5, 2019

(54) AUTOMATED CAR SERVICE SCHEDULE SYSTEM

(71) Applicant: Eddie Strong, Mesa, US (US)

(72) Inventor: Eddie Strong, Mesa, US (US)

(21) Appl. No.: 16/290,563

(22) Filed: Mar. 1, 2019

Related U.S. Application Data
(60) Provisional application No. 62/637,124, filed on Mar. 1, 2018.

(51) Int. Cl. G06Q 10/10; G06Q 30/06; G07C 9/00

(52) U.S. Cl. CPC G06Q 10/1095; H04N 1/00251; G07C 9/00309; G06Q 30/0637

(57) ABSTRACT

An automated car service schedule system is provided. The system includes a computer server having a memory storing user data, wherein the user data includes user contact information and user vehicle information, a user computing device and a technician computing device, each coupled to the computer server. The computer server is programmed to receive from the user computing device a service request and the computer server communicates with the user computing device and the technician computing device in order to complete service of the vehicle in accordance with the service request.

### BACKGROUND OF THE INVENTION

### Technical Field

This invention relates generally to a car service system and more particularly to an automated car service schedule system.

### State of the Art

In order to obtain service of a vehicle, the owner must work out a time to take the vehicle to a particular service shop. The owner may then wait for service to be completed or arrange a ride away from the shop and wait for communication from the service shop that the vehicle service is completed. The owner then must get back to the service shop, pay for the service performed and take the vehicle. This is always done during business hours and is often difficult for owners because of work or the like.

Accordingly, there is a need for an improved car service schedule system.

### SUMMARY OF THE INVENTION

An embodiment of the present invention includes an automated car service schedule system comprising: a computer server comprising a memory storing user data, wherein the user data includes a user name, a password, user contact information and user vehicle information; and a user computing device coupled to the computer server, the computer server programmed to: receive from the user computing device a signal indicating a service request for a user vehicle, including a requested time for performance of service; automatically process the signal received from the user computing device and retrieve the stored user data; and using the user data retrieved, automatically generate and transmit to the user computing device acceptance of the service request and a cost associated with the service request.

Another embodiment includes an automated car service schedule system comprising: a computer server comprising a memory storing user data, wherein the user data includes user contact information and user vehicle information; a user computing device coupled to the computer server; and a technician computing device coupled to the computer server, the computer server programmed to: automatically generate and transmit to the technician computing device information related to a service request; receive from the technician computing device a signal indicating acceptance of the service request; automatically process the signal received from the technician computing device and retrieve user vehicle data and location data of the user vehicle to be serviced; and using the user vehicle data and location data retrieved, automatically generate and transmit to the technician computing device GPS directions to the user vehicle to be serviced, a photo of the user vehicle and a license plate number of the user vehicle for display on the technician computing device.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of an automated car service schedule system in accordance with an embodiment;

FIG. 2 is a flow chart of programmed steps of an automated car service schedule system in accordance with an embodiment; and

FIG. 3 is a flow chart of programmed steps of an automated car service schedule system in accordance with an embodiment.

### DETAILED DESCRIPTION OF EMBODIMENTS OF THE INVENTION

As discussed above, embodiments of the present invention relate to an automated car service schedule system. This provides more of an on demand vehicle service system and further may be utilized off-hours in order to have a vehicle serviced when the owner/user is not using the vehicle.

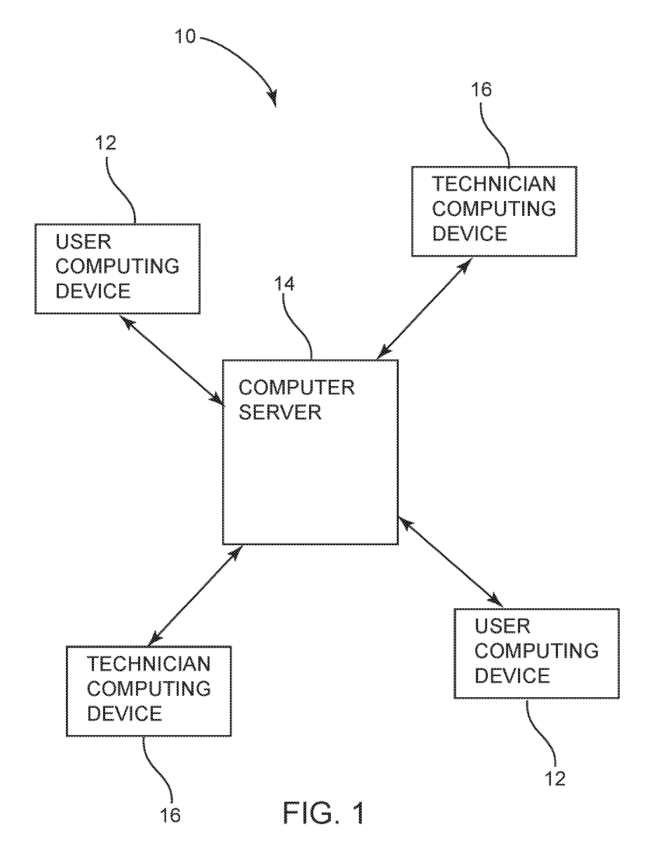

Referring to the drawings, FIG. 1 depicts an embodiment of an automated car service schedule system 10. The system 10 may include user computing devices 12, technician computing devices 16, and a computer server 14, wherein the user computing devices 12 and the technician computing devices 16 are coupled to the computer server 14. This coupling may be a network connection, such as through an Internet connection, wherein the user computing devices 12 and the technician computing devices 16 may communicate with and receive communication from the server 14.

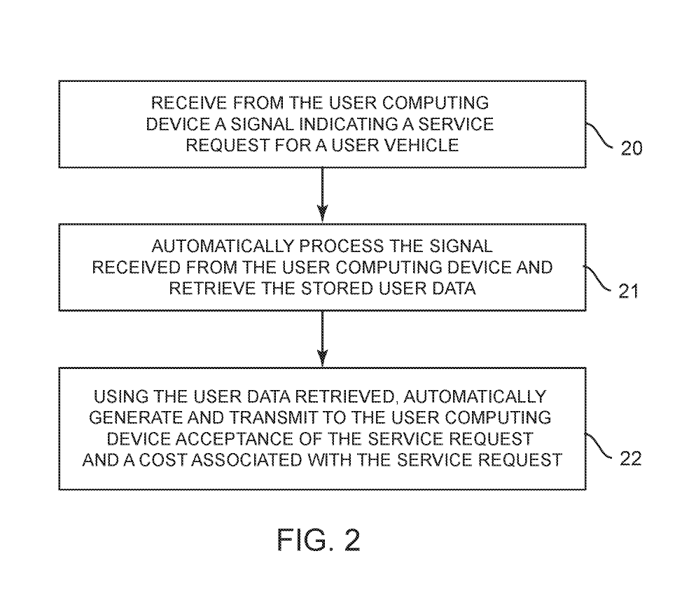

The computer server 14 may include a memory storing user data, wherein the user data includes a user name, a password, user contact information and user vehicle information. The user computing device 12 may be coupled to the computer server 14, and, referring to FIG. 2, the computer server 14 may be programmed to receive from the user computing device 12 a signal indicating a service request for a user vehicle, including a requested time for performance of service (Step 20); automatically process the signal received from the user computing device 12 and retrieve the stored user data (Step 21); and using the user data retrieved, automatically generate and transmit to the user computing device 12 acceptance of the service request and a cost associated with the service request (Step 22).

In embodiments, the system 10 may include a lock box for storing a key by the user after requesting the service. The lock box may be accessible by a code and may do so via Bluetooth or other type of wireless communication such as near field communication (NFC) and the like. The lock box may be password protected and a technician that picks up the vehicle may be provided with a code that opens the lock box, wherein the code may be transmitted from the technician computing device 16 to the lock box. In embodiments, the code may be a one-time use code.

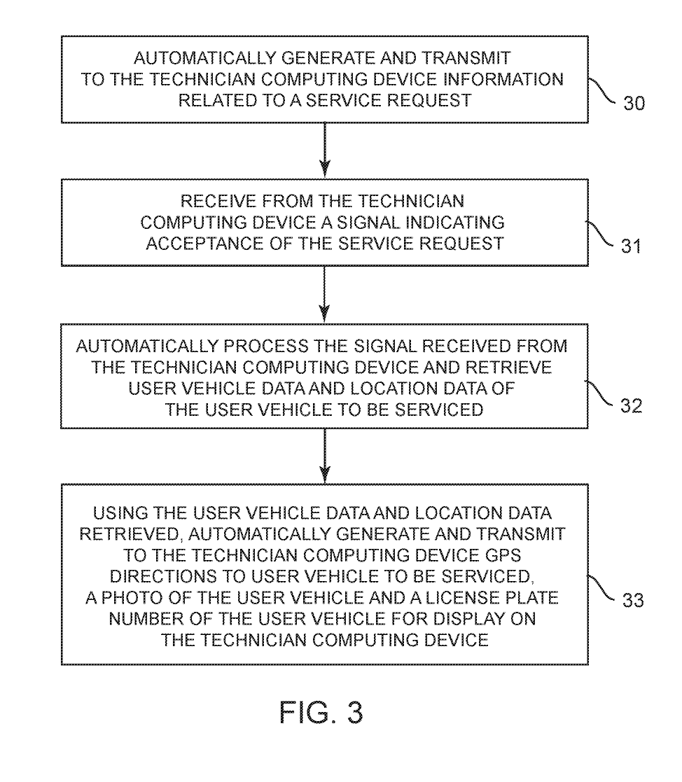

The computer server 14 may include a memory storing user data, wherein the user data includes a user name, a password, user contact information and user vehicle information. The user computing device 12 may be coupled to the computer server 14, and, referring to FIG. 3, the computer server 14 may be programmed to automatically generate and transmit to the technician computing device 16 information related to a service request (Step 30); receive from the technician computing device 16 a signal indicating acceptance of the service request (Step 31); automatically process the signal received from the technician computing device 16 and retrieve user vehicle data and location data of the user vehicle to be serviced (Step 32); and using the user vehicle data and location data retrieved, automatically generate and transmit to the technician computing device 16 GPS directions to user vehicle to be serviced, a photo of the user vehicle and a license plate number of the user vehicle for display on the technician computing device (Step 33).

In embodiments, when multiple service requests and have been received and accepted by the system 10, the computer server 14 may be programmed to determine the most efficient and/or economical routes to pick up and deliver each user vehicle with open service requests in order to most efficiently deliver vehicles to the service center for receiving service.

The technician may then use the data sent by the computer server 14 to drive to the user vehicle and pick it up. The technician may then utilize the technician computing device to confirm pick up of the user vehicle, such as taking a picture of the vehicle and transmitting it to the server 14 through use of the technician computing device 16. The computer server 14 is programmed to receive and process the information transmitted by the technician computing device and automatically generates and transmits GPS directions to a service center of the system 10. Once service is completed on the user vehicle, the technician returns the vehicle and upon notifying the computer server 14 that the vehicle is returned, the computer server 14 is programmed to automatically process payment with a stored form of payment and generate and transmit to the user computing device 12 a completion of service notice and receipt. In embodiments, the technician computing device 16 may be utilized to send updates on the service(s) being performed to the computer server 14, wherein the computer server 14 receives and processes the update information and automatically generates and transmits update information to the user computing device 12.

It will be appreciated that the service requests may include various types of vehicle service, such as, but not limited to cleaning the vehicle, detailing the vehicle, filling gas, changing oil, tire rotation, battery check and replacement, fluid check and replacement, and the like. It will also be appreciated that many services may be performed by a technician at the vehicle's location, without picking up the vehicle and moving it to a service center. For example, may vehicle services may be performed at the vehicle owner's residence or place of business.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

What is claimed is:

1. An automated car service schedule system comprising:
a computer server having a memory storing user data, user vehicle information, and vehicle service availability and cost data;
a user computing device coupled to the computer server, wherein the computer server is programmed to:
receive from the user computing device a signal indicating a service request for a user vehicle, in response to user input to the user computing device;
automatically process the signal received from the user computing device and retrieve the stored user data and vehicle service availability and cost data; and
using the user data and vehicle service availability and cost data retrieved, automatically generate and transmit to the user computing device acceptance of the service request and a cost associated with the service request.

2. The system of claim 1, further comprising a technician computing device coupled to the computer server, wherein the computer server is further programmed to: automatically generate and transmit to the technician computing device information related to the service request in response to processing the service request; receive from the technician computing device a signal indicating acceptance of the service request; and automatically process the signal received from the technician computing device and retrieve user vehicle data and location data of the user vehicle to be serviced; and using the user vehicle data and location data retrieved, automatically generate and transmit to the accepting technician computing device user vehicle information and GPS directions to the user vehicle to be serviced

3. The system of claim 2, wherein each of the technician computing device includes a camera.

4. The system of claim 3, wherein the computer server is further programmed to receive and store in memory photographs, videos or a combination of photographs and videos of the user vehicle taken with and transmitted from the technician computing device as confirmation of completion of the service requested in response to technician input to the accepting technician computing device.

5. The system of claim 4, wherein the computer server is further programmed to automatically transmit the photographs, videos, or combination of photographs and videos of the user vehicle to the user computing device as confirmation of completion of the service requested.

6. An automated car service schedule system comprising:
a computer server having a memory storing user data, user vehicle information, technician information, and vehicle service availability and cost data;
a plurality of technician computing devices coupled to the computer server, and
a plurality of user computing devices coupled to the computer server, wherein the computer server is programmed to:
receive from one of the plurality of user computing devices a signal indicating a service request for a user vehicle, including location data of the user vehicle, in response to user input to the user computing device;
automatically generate and transmit to the plurality of technician computing devices information related to a service request;
receive from one of the plurality of technician computing devices a signal indicating acceptance of the service request;
automatically process the signal received from the accepting technician computing device and retrieve user vehicle data and location data of the user vehicle to be serviced;
using the user vehicle data and location data retrieved, automatically generate and transmit to the accepting technician computing device user vehicle information and GPS directions to the user vehicle to be serviced,

7. The automated car service schedule system of claim 6, wherein the user vehicle information includes at least one of a photo of the user vehicle and a license plate number of the user vehicle for display on the accepting technician computing device.

8. The automated car service schedule system of claim 6, further comprising:
a lock box communicatively coupled to the accepting technician computing device, wherein the lock box contains a key for opening the vehicle with which the user vehicle information is associated.

9. The automated car service schedule system of claim 8, wherein the user vehicle information includes a code that opens the lock box upon being transmitted to the lock box from the accepting technician computing device.

10. The automated car service schedule system of claim 6, wherein each of the plurality of technician computing devices includes a camera.

11. The automated car service schedule system of claim 10, wherein the computer server is further programmed to receive and store in memory photographs, videos or combination of photographs and videos of the user vehicle taken with and transmitted from the accepting technician computing device as confirmation of completion of the service requested in response to technician input to the accepting technician computing device.

12. The automated car service schedule system of claim 11, wherein the computer server is further programmed to automatically transmit the photographs, videos, or combination of photographs and videos of the user vehicle to the user computing device as confirmation of completion of the service requested.

13. The automated car service schedule system of claim 6, wherein the computer server is further programmed to receive service requests from a plurality of user computing devices and automatically generate and transmit to the plurality of technician computing devices information related to the service requests received from the plurality of user computing devices.

14. The automated car service schedule system of claim 13, wherein the computer server is further programmed to receive from one of the plurality of technician computing devices a signal indicating acceptance of a plurality of service requests, and determine route information, including the most efficient and/or economical route for the accepting technician to fulfill the plurality of service requests, and automatically transmit the route information to the accepting technician computing device for display on the accepting technician computing device.

15. The automated car service schedule system of claim 6, wherein the user data includes a form of payment, wherein the computer server is further programmed to automatically process payment with the stored form of payment and generate and transmit to the user computing device a completion of service notice and receipt.

16. The automated car service schedule system of claim 6, wherein the computer server is further programmed to receive service status updates from the accepting technician computing device, in response to technician input to the technician computing device; and, using the service status updates, automatically generate and transmit service status update information to the user computing device.
